(19) United States
(12) Patent Application Publication
(10) Pub. No.: US 2026/0128448 A1
(43) Pub. Date: May 7, 2026

(54) BATTERY PACK

(71) Applicant: MURATA MANUFACTURING CO., LTD., Kyoto (JP)

(72) Inventor: Yuta NIKAIDO, Kyoto (JP)

(21) Appl. No.: 19/436,660

(22) Filed: Dec. 30, 2025

Related U.S. Application Data
(63) Continuation of application No. PCT/JP2024/018768, filed on May 22, 2024.

(30) Foreign Application Priority Data
Aug. 14, 2023 (JP) 2023-132006

(51) Int. Cl. H01M 50/291; H01M 10/653; H01M 10/659; H01M 50/209; H01M 50/213; H01M 50/293

(52) U.S. Cl. CPC H01M 50/291; H01M 10/653; H01M 10/659; H01M 50/209; H01M 50/213; H01M 50/293

(57) ABSTRACT

A battery pack includes a battery and a heat-absorbing member. The heat-absorbing member includes a heat-absorbing agent and a container housing the heat-absorbing agent. The heat-absorbing member is disposed at a position adjacent to the battery. The container includes a stacked body including a resin layer and a metal layer in this order from a side closer to the heat-absorbing agent. The stacked body has a hole extending through the resin layer and the metal layer. A region around the hole is sealed by the resin layer around the hole.

### CROSS REFERENCE TO RELATED APPLICATIONS

The present application is a continuation of International Application No. PCT/JP2024/018768, filed on May 22, 2024, which claims priority to Japanese Patent Application No. 2023-132006, filed on Aug. 14, 2023, the entire contents of which are incorporated herein by reference.

### BACKGROUND

The present technology relates to a battery pack.

Electronic equipment have been widely used, which has promoted development of a battery as a power source to be applied to the electronic equipment. In this case, in order to handle multiple batteries easily and safely, a battery pack including the multiple batteries has been proposed.

A technique related to a configuration of the battery pack has been considered in various ways. For example, a heat-absorbing member is disclosed that is brought into contact with a battery in a battery unit, and the battery that has generated abnormal heat is cooled by the heat-absorbing member.

### SUMMARY

The present technology relates to a battery pack.

Regarding a battery pack, there is a concern that it can be difficult to sufficiently cool a battery that has generated abnormal heat by a heat-absorbing member, depending on an arrangement or a structure of the heat-absorbing member. It is desirable to provide a battery pack that makes it possible to sufficiently cool a battery that has generated abnormal heat by a heat-absorbing member.

A battery pack according to an embodiment of the present technology includes a battery and a heat-absorbing member. The heat-absorbing member includes a heat-absorbing agent and a container housing the heat-absorbing agent. The heat-absorbing member is disposed at a position adjacent to the battery. The container includes a stacked body including a resin layer and a metal layer in this order from a side closer to the heat-absorbing agent. The stacked body has a hole extending through the resin layer and the metal layer. A region around the hole is sealed by the resin layer around the hole.

A battery pack according to an embodiment of the present technology includes a battery and a heat-absorbing member. The heat-absorbing member includes a heat-absorbing agent and a container housing the heat-absorbing agent. The battery and the container each have a flat plate shape. The container has a first surface, a second surface, and a through hole. The first surface is disposed at a position adjacent to the battery. The second surface is opposed to the first surface with the heat-absorbing agent interposed therebetween. The through hole extends through the first surface and the second surface. A region around the through hole is sealed by a part, of the first surface, around the through hole and a part, of the second surface, around the through hole.

According to the battery pack of an embodiment of the present technology, the container housing the heat-absorbing agent includes the stacked body including the resin layer and the metal layer, and the region around the hole extending through the stacked body is sealed by the resin layer around the hole. As a result, a welded part of the resin layer is peeled off by heat of the battery that has generated abnormal heat, allowing the heat-absorbing agent released from the hole to come into contact with and cool the battery that has generated abnormal heat. Providing the welded part of the resin layer at a desired location of the container thus makes it possible to effectively cool the battery that has generated abnormal heat. Accordingly, it is possible to sufficiently cool the battery that has generated abnormal heat by the heat-absorbing member.

According to the battery pack of an embodiment of the present technology, the region around the through hole extending through the first surface and the second surface of the container housing the heat-absorbing agent is sealed by the part, of the first surface, around the through hole and the part, of the second surface, around the through hole. As a result, a welded part of the container is peeled off by heat of the battery that has generated abnormal heat, allowing the heat-absorbing agent released from the container to come into contact with and cool the battery that has generated abnormal heat. Providing the welded part at a desired location of the container thus makes it possible to effectively cool the battery that has generated abnormal heat. Accordingly, it is possible to sufficiently cool the battery that has generated abnormal heat by the heat-absorbing member.

Note that effects of the present technology are not necessarily limited to those described herein and may include any of a series of effects including described below in relation to the present technology.

### BRIEF DESCRIPTION OF THE FIGURES

FIG. 1 is a diagram illustrating a perspective configuration example of a battery pack according to an embodiment of the present technology.

FIG. 2 is a diagram illustrating a perspective configuration example of a battery module to be housed in the battery pack of FIG. 1.

FIG. 3 is a diagram illustrating an exploded perspective configuration example of the battery pack of FIG. 1.

FIG. 4 is a diagram illustrating a sectional configuration example of the battery module of FIG. 2.

FIG. 5 is a diagram illustrating a perspective configuration example of a heat-absorbing module of FIG. 4.

FIG. 6 includes Part (A) that is a diagram illustrating a perspective configuration example of a heat-absorbing member of FIG. 5. Part (B) of FIG. 6 is a diagram illustrating a sectional configuration example of the heat-absorbing member of part (A) of FIG. 6 taken along line A-A. Part (C) of FIG. 6 is a diagram illustrating a sectional configuration example of the heat-absorbing member of part (A) of FIG. 6 taken along line B-B.

FIG. 7 is a diagram illustrating a partial sectional configuration example of the heat-absorbing member of part (A) of FIG. 6.

FIG. 8 includes Part (A) that is a diagram illustrating, in an enlarged manner, a partial sectional configuration example of part (B) of FIG. 6. Part (B) of FIG. 8 is a diagram illustrating, in an enlarged manner, a partial sectional configuration example of part (C) of FIG. 6. Part (C) of FIG. 8 is a diagram illustrating, in an enlarged manner, a partial sectional configuration example of a flange part of part (A) of FIG. 6.

FIG. 9 is a diagram illustrating a side configuration example of the heat-absorbing member of part (A) of FIG. 6.

FIG. 10 is a diagram illustrating, in an enlarged manner, a partial perspective configuration example of the heat-absorbing member of part (A) of FIG. 6.

FIG. 11 includes Part (A) of FIG. 11 that is a diagram illustrating an example of a manufacturing process of a hole. Part (B) of FIG. 11 is a diagram illustrating an example of a manufacturing process following part (A) of FIG. 11. Part (C) of FIG. 11 is a diagram illustrating an example of a manufacturing process following part (B) of FIG. 11.

FIG. 12 is a diagram illustrating one modification example of a sectional configuration of the heat-absorbing member of part (B) of FIG. 8.

FIG. 13 includes Part (A) that is a diagram illustrating one modification example of a perspective configuration of the heat-absorbing member of part (A) of FIG. 6. Part (B) of FIG. 13 is a diagram illustrating a sectional configuration example of the heat-absorbing member of part (A) of FIG. 13 taken along line A-A. Part (C) of FIG. 13 is a diagram illustrating a sectional configuration example of the heat-absorbing member of part (A) of FIG. 13 taken along line B-B.

FIG. 14 is a diagram illustrating one modification example of a planar configuration of the battery module of FIG. 2.

FIG. 15 is a diagram illustrating an exploded perspective configuration example of the battery module of FIG. 14.

FIG. 16 is a diagram illustrating a perspective configuration example of a heat-absorbing member of FIG. 15.

FIG. 17 is a diagram illustrating a sectional configuration example of the heat-absorbing member of FIG. 16 taken along line A-A.

FIG. 18 is a diagram illustrating one modification example of a sectional configuration of the heat-absorbing member of FIG. 15.

FIG. 19 is a diagram illustrating one modification example of a sectional configuration of the heat-absorbing member of FIG. 17.

FIG. 20 is a diagram illustrating one modification example of a sectional configuration of the heat-absorbing member of FIG. 18.

### DETAILED DESCRIPTION

The present technology is described below in further detail including with reference to the drawings according to an embodiment.

A description is given first of a battery pack according to an embodiment of the present technology.

The battery pack to be described here is a power source including multiple batteries and is to be applied to a variety of uses such as electronic equipment. Details of the uses of the battery pack will be described later. The battery is not particularly limited in kind and may be a primary battery or a secondary battery. The secondary battery is not particularly limited in kind, but is specifically, for example, a lithium-ion secondary battery in which a battery capacity is obtainable through insertion and extraction of lithium ions. The number of batteries is not particularly limited, and may be set as desired. Hereinafter, a case in which the battery is a secondary battery (a lithium-ion secondary battery) will be described. In other words, the battery pack described below is a power source including multiple secondary batteries.

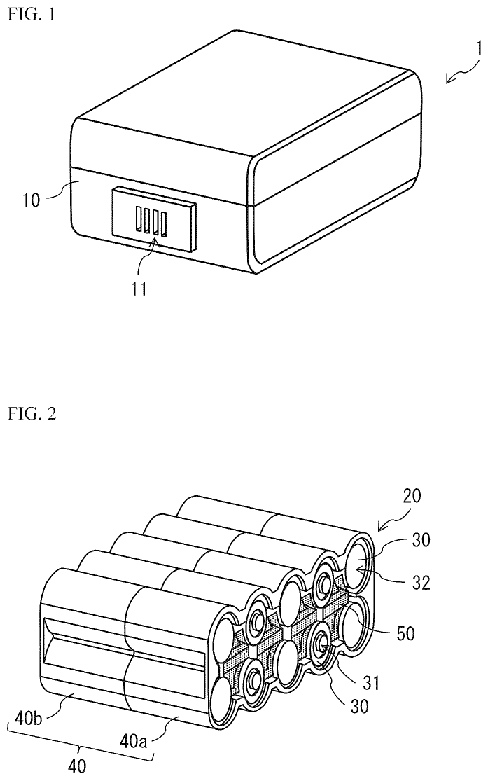

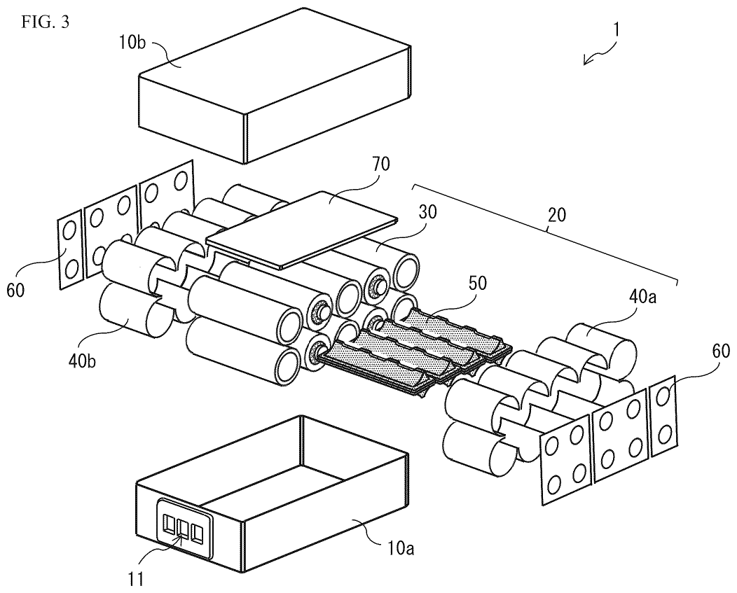

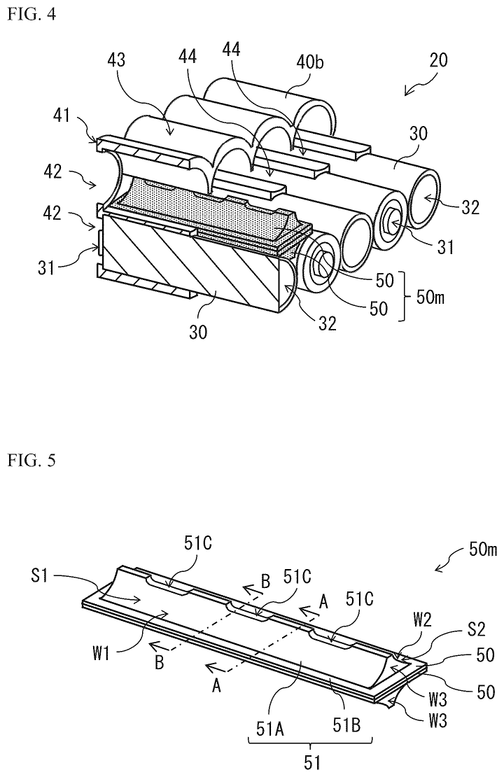

FIG. 1 illustrates a perspective configuration example of a battery pack 1 according to an embodiment of the present technology. FIG. 2 illustrates a perspective configuration example of a battery module 20 to be housed in the battery pack 1. FIG. 3 illustrates an exploded perspective configuration example of the battery pack 1. FIG. 4 illustrates a sectional configuration example of the battery module 20.

The battery pack 1 includes an outer casing 10, the battery module 20, multiple metal tabs 60, and a control board 70, for example, as illustrated in FIGS. 1 to 3. The control board 70 is, for example, coupled to positive and negative electrode terminals of the battery module 20 via the multiple metal tabs 60 and includes a circuit that performs operations such as measuring a voltage of the batteries or the battery module 20, detecting a remaining capacity of the battery module 20, and detecting presence or absence of an overcurrent by measuring a current outputted from the battery module 20.

The outer casing 10 houses the battery module 20, the multiple metal tabs 60, and the control board 70. The outer casing 10 includes a lower casing 10a and an upper casing 10b, for example, as illustrated in FIG. 3. The lower casing 10a and the upper casing 10b are stacked on each other to form a housing space that houses the battery module 20, the multiple metal tabs 60, and the control board 70. The outer casing 10 (for example, the lower casing 10a) is provided with an external terminal 11 coupled to the control board 70. The battery module 20 is coupled to the external terminal 11 via the control board 70.

The battery pack 1 has a discharge mode in which electric power outputted from the battery module 20 is supplied to a load via the external terminal 11. The battery pack 1 may further have a charge mode in which electric power supplied via the external terminal 11 from a power source coupled to the external terminal 11 is accumulated in the battery module 20. When a battery 30 to be described later is a secondary battery, the control board 70 switches between the discharge mode and the charge mode in accordance with a kind of a coupled object coupled to the external terminal 11. When the battery 30 to be described later is a primary battery, the control board 70 executes only the discharge mode.

The battery module 20 includes multiple batteries 30, for example, as illustrated in FIGS. 2 and 3. The multiple batteries 30 are electrically coupled to each other via the multiple metal tabs 60. Each of the batteries 30 includes a positive electrode 31 and a negative electrode 32, for example, as illustrated in FIG. 2. Each of the batteries 30 includes, for example, a cylindrical battery in which the positive electrode 31 and the negative electrode 32 extend in opposite directions to each other. In the battery module 20, for example, some of the multiple batteries 30 are coupled in series with each other by the metal tabs 60. Further, when the batteries 30 coupled in series with each other are referred to as a series unit, multiple series units are coupled in parallel with each other by the metal tabs 60. Note that how the multiple batteries 30 are coupled to each other is not limited to the above.

Each of the metal tabs 60 includes, for example, a metal lead plate. Each of the batteries 30 is a primary battery or a secondary battery. When each of the batteries 30 is a secondary battery, the secondary battery is not particularly limited in kind, but is specifically, for example, a lithium-ion secondary battery in which a battery capacity is obtainable through insertion and extraction of lithium ions. Hereinafter, a case in which each of the batteries 30 is a secondary battery (a lithium-ion secondary battery) will be described. In other words, the battery pack 1 described below is a power source including multiple secondary batteries.

The battery module 20 further includes a battery holder 40 that supports the multiple batteries 30, and multiple heat-absorbing members 50 disposed between the multiple batteries 30, for example, as illustrated in FIGS. 2 and 3. The battery holder 40 has a structure that supports the multiple batteries 30 in layered form with a predetermined gap therebetween. The heat-absorbing members 50 will be described in detail later.

FIG. 4 illustrates a sectional configuration example of the battery module 20. The battery holder 40 includes a pair of holders 40a and 40b, for example, as illustrated in FIGS. 3 and 4. The holders 40a and 40b have a common structure.

Each of the holders 40a and 40b includes a side plate part 41, for example, as illustrated in FIG. 4. The side plate part 41 of the holder 40a and the side plate part 41 of the holder 40b are disposed to be opposed to each other with the multiple batteries 30 interposed therebetween in an extending direction of each of the batteries 30 (a direction in which the positive electrode 31 and the negative electrode 32 are opposed to each other). In the holders 40a and 40b, the side plate parts 41 have openings 42 at locations opposed to the positive electrodes 31 and the negative electrodes 32 of the batteries 30. Thus, the positive electrode 31 or the negative electrode 32 is exposed in each of the openings 42.

Each of the holders 40a and 40b further includes a support part 43 that supports the multiple batteries 30 in layered form with a predetermined gap therebetween, for example, as illustrated in FIG. 4. The side plate part 41 is coupled to each of two opposite end parts of the support parts 43 as a whole. Here, it is assumed that the support parts 43 support four or more cylindrical batteries 30 in layered form with a predetermined gap therebetween. In this case, the support parts 43 have openings 44 at locations surrounded by four cylindrical batteries 30 adjacent to each other, for example, as illustrated in FIG. 4. A heat-absorbing module 50m including two heat-absorbing members 50 stacked on each other is disposed at a position surrounded by four cylindrical batteries 30 adjacent to each other, for example, as illustrated in FIGS. 4 and 5. The heat-absorbing module 50m is in contact with outer peripheral surfaces of the four cylindrical batteries 30 in each opening 44.

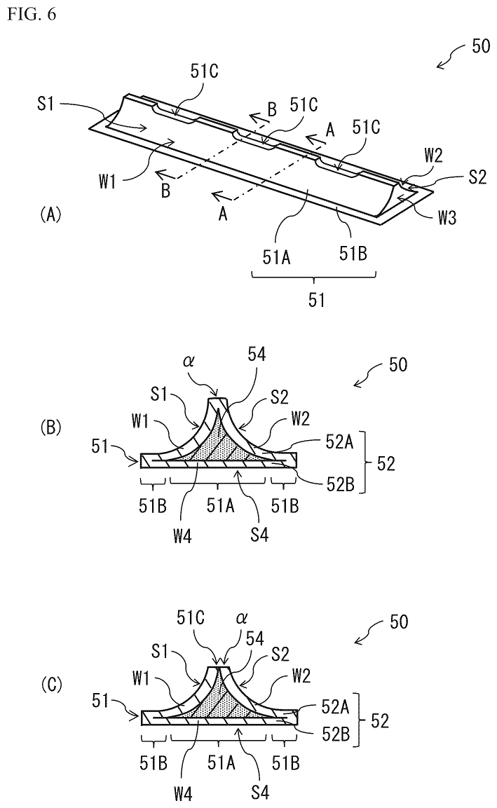

The heat-absorbing module 50m extends in a direction parallel to the extending direction of each of the batteries 30 (the direction in which the positive electrode 31 and the negative electrode 32 are opposed to each other). Each of the heat-absorbing members 50 included in the heat-absorbing module 50m also extends in a direction parallel to the extending direction of each of the batteries 30 (the direction in which the positive electrode 31 and the negative electrode 32 are opposed to each other). In the heat-absorbing module 50m, one of the heat-absorbing members 50 is in contact with the outer peripheral surfaces of two batteries 30 disposed in an upper layer among the four cylindrical batteries 30 adjacent to each other, and the other heat-absorbing member 50 is in contact with the outer peripheral surfaces of two batteries 30 disposed in a lower layer among the four cylindrical batteries 30 adjacent to each other. In the heat-absorbing module 50m, respective flat surfaces of the two heat-absorbing members 50 (flat surfaces S4 to be described later (see part (B) of FIG. 6)) are stacked on each other. Each opening 44 is in contact with the side plate part 41 of the holder 40a and the side plate part 41 of the holder 40b. Each heat-absorbing member 50 is in contact with the side plate part 41 of the holder 40a and the side plate part 41 of the holder 40b in the opening 44.

Part (A) of FIG. 6 illustrates a perspective configuration example of the heat-absorbing member 50. Part (B) of FIG. 6 illustrates a sectional configuration example of the heat-absorbing member 50 taken along line A-A. Part (C) of FIG. 6 illustrates a sectional configuration example of the heat-absorbing member 50 taken along line B-B. The heat-absorbing member 50 has a shape corresponding to a shape of the gap between the multiple batteries 30 supported by the battery holder 40 (the support parts 43). The heat-absorbing member 50 has an elongated columnar shape. Here, it is assumed that four or more cylindrical batteries 30 are supported by the battery holder 40 (the support parts 43) in layered form with a predetermined gap therebetween. In this case, the heat-absorbing module 50m including two heat-absorbing members 50 stacked on each other is in contact with surfaces (the outer peripheral surfaces) of four cylindrical batteries 30 adjacent to each other, and has, for example, a shape corresponding to the shape of the gap between the four cylindrical batteries 30 adjacent to each other. A section, of the heat-absorbing module 50m, in a direction perpendicular to the extending direction of the heat-absorbing module 50m has a substantially rhombic shape. In this case, a section, of the heat-absorbing member 50, in a direction perpendicular to the extending direction of the heat-absorbing member 50 has a substantially triangular shape, for example, as illustrated in part (B) of FIG. 6.

Here, two cylindrical batteries 30 adjacent to each other are referred to as a first battery 30 and a second battery 30. In this case, the heat-absorbing member 50 has an arc wall W1 (an arc surface S1) extending along the outer peripheral surface of the first battery 30, and an arc wall W2 (an arc surface S2) extending along the outer peripheral surface of the second battery 30. The arc wall W2 is disposed at a position adjacent to the arc wall W1. The two arc walls W1 and W2 (or the two arc surfaces S1 and S2) each have a concave shape conforming to the outer peripheral surface of the battery 30. The arc wall W1 corresponds to a specific example of a “first stacked part” of the present technology. The arc wall W2 corresponds to a specific example of a “second stacked part” of the present technology. The heat-absorbing member 50 further has, at each of two opposite end parts in a longitudinal direction of the heat-absorbing member 50, an end wall W3 constituting a part of the end part in the longitudinal direction of the heat-absorbing member 50. The heat-absorbing member 50 further has a flat wall W4 (the flat surface S4) at a location opposed to the arc walls W1 and W2 with a heat-absorbing agent 54 to be described later interposed therebetween. The end wall W3 is disposed at a position adjacent to both of the arc walls W1 and W2. The end wall W3 corresponds to a specific example of a “third stacked part” of the present technology.

The heat-absorbing member 50 includes the heat-absorbing agent 54 and a container 51 covering the heat-absorbing agent 54, for example, as illustrated in part (B) of FIG. 6.

The container 51 covers the heat-absorbing agent 54. The container 51 is formed by, for example: thermal-fusion-bonding a stacked part 52A to be described later and a stacked part 52B to be described later to each other into a container, leaving one side open; filling the container with the heat-absorbing agent 54; and thereafter thermal-fusion-bonding the remaining one side used as a filling port. Accordingly, the container 51 houses the heat-absorbing agent 54. A stacked body 52 thus shaped includes the stacked part 52A and the stacked part 52B, for example, as illustrated in part (B) of FIG. 6. The stacked part 52A constitutes the arc walls W1 and W2 and the end walls W3, and the stacked part 52B constitutes the flat wall W4. The stacked part 52A and the stacked part 52B are, for example, integrated with each other, and are coupled to each other at a flange part 51B to be described later.

The container 51 includes a housing part 51A housing the heat-absorbing agent 54, and the flange part 51B provided around the housing part 51A, for example, as illustrated in FIG. 5 and part (A) of FIG. 6. The housing part 51A corresponds to a substantially triangular-prism-shaped part, of the container 51, constituted by the arc walls W1 and W2, the end walls W3, and a part of the flat wall W4. The flange part 51B corresponds to a plate-shaped part, of the container 51, provided to surround the housing part 51A, as viewed from a direction normal to the flat wall W4.

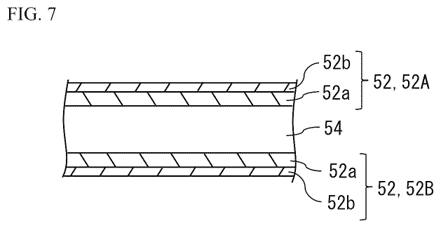

The container 51 (the stacked body 52, the stacked part 52A, and the stacked part 52B) includes a resin layer including a thermoplastic material. The container 51 (the stacked body 52, the stacked part 52A, the stacked part 52B) includes, for example, a resin layer 52a illustrated in FIG. 7. The resin layer 52a includes, for example, a resin material such as polyethylene, polystyrene, polypropylene, or polycarbonate.

The container 51 (the stacked body 52, the stacked part 52A, and the stacked part 52B) may include, for example, stacked films. The container 51 (the stacked body 52, the stacked part 52A, and the stacked part 52B) includes the resin layer 52a and a metal layer 52b in this order from a side closer to the heat-absorbing agent 54, for example, as illustrated in FIG. 7. In this case, the container 51 (the stacked body 52, the stacked part 52A, and the stacked part 52B) includes the resin layer 52a. The metal layer 52b includes, for example, a metal foil such as an aluminum foil.

The heat-absorbing agent 54 includes, for example, a liquid including water, or a hydrogel. When using the hydrogel as the heat-absorbing agent 161, it is preferable to use a synthetic polymer gel. Examples of a material of the synthetic polymer gel include sodium polyacrylate (PNaAA), polyvinyl alcohol (PVA), polyhydroxyethyl methacrylate (PHE-MA), and silicone hydrogel.

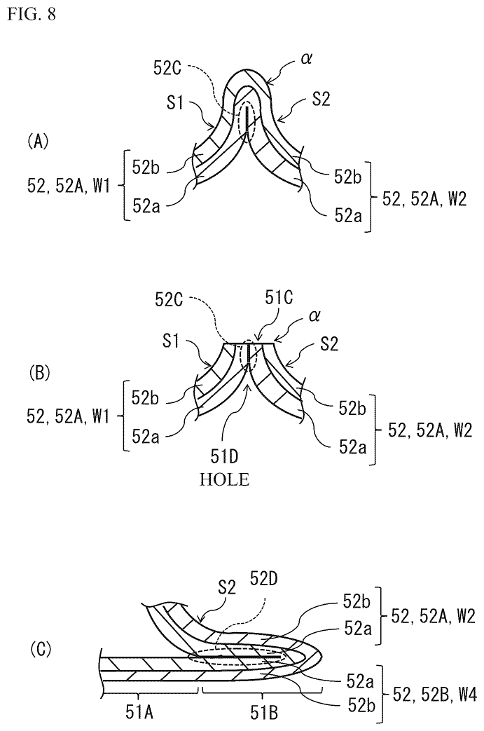

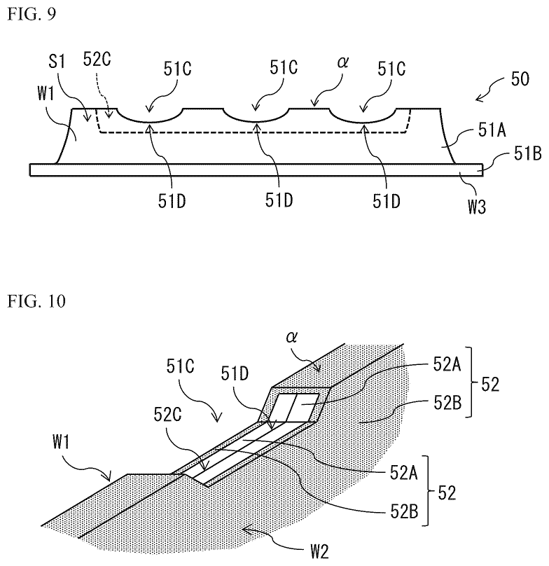

Part (A) and part (B) of FIG. 8 each illustrate, in an enlarged manner, a folded-back part, of the housing part 51A, provided in the stacked part 52A. Part (A) of FIG. 8 illustrates, in an enlarged manner, a spot, of the folded-back part, taken along line A-A of part (A) of FIG. 6. Part (B) of FIG. 8 illustrates, in an enlarged manner, a spot, of the folded-back part, taken along line B-B of part (A) of FIG. 6. Part (C) of FIG. 8 illustrates the flange part 51B in an enlarged manner. FIG. 9 illustrates a side configuration example of the heat-absorbing member 50. FIG. 10 illustrates a part of the heat-absorbing member 50 in an enlarged manner.

The stacked part 52A has a shape that is bent at an acute angle at a boundary α between the arc wall W1 and the arc wall W2, for example, as illustrated in part (B) of FIG. 6 and part (A) of FIG. 8. At the boundary α between the arc wall W1 and the arc wall W2, i.e., the bent part, a part of the resin layer 52a of the arc wall W1 and a part of the resin layer 52a of the arc wall W2 are welded to each other, for example, as illustrated in part (A) of FIG. 8 and FIG. 9. The boundary α between the arc wall W1 and the arc wall W2, i.e., the bent part, is sealed by, for example, adhesion between the part of the resin layer 52a of the arc wall W1 and the part of the resin layer 52a of the arc wall W2. A part where the part of the resin layer 52a of the arc wall W1 and the part of the resin layer 52a of the arc wall W2 are welded to each other for sealing is a welded part 52C in part (A) of FIG. 8 and FIG. 9. At an end part of the flange part 51B, a part of the resin layer 52a of the arc wall W2 and a part of the resin layer 52a of the flat wall W4 are welded to each other, for example, as illustrated in part (C) of FIG. 8. The end part of the flange part 51B is sealed by, for example, adhesion between the part of the resin layer 52a of the arc wall W2 and the part of the resin layer 52a of the flat wall W4. Apart where the part of the resin layer 52a of the arc wall W2 and the part of the resin layer 52a of the flat wall W4 are welded to each other for sealing is a welded part 52D in part (C) of FIG. 8.

The flange part 51B is provided with no cutout or through hole, for example, as illustrated in part (C) of FIG. 8. Therefore, the flange part 51B is covered with the metal layer 52b, and the heat-absorbing agent 54 is not released to an outside from the flange part 51B. In contrast, the stacked part 52A has one or more cutouts 51C at the boundary α between the arc wall W1 and the arc wall W2, i.e., the bent part, for example, as illustrated in part (C) of FIG. 6, part (B) of FIG. 8, FIG. 9, and FIG. 10. The one or more cutouts 51C are disposed close to peripheral surfaces of both the first battery 30 and the second battery 30 described above. The one or more cutouts 51C are provided at one or more positions spaced from the end wall W3. Each of the cutouts 51C is provided in a middle region in a longitudinal direction of the container 51. Here, the term “middle region” refers to, for example, a region that is away from each of the end walls W3 by a length equal to a height of the end wall W3, at the boundary α, i.e., the bent part, extending between the two end walls W3.

The welded part 52C is exposed on a surface of each of the cutouts 51C, for example, as illustrated in part (B) of FIG. 8 and FIG. 10. In other words, each of the cutouts 51C extends through the stacked part 52A. Therefore, at each of the cutouts 51C, when the welded part 52C is melted by, for example, heat of the battery 30 that has generated abnormal heat, the heat-absorbing agent 54 leaks to the outside (e.g., the peripheral surface of the battery 30 that has generated abnormal heat) via each of the cutouts 51C. Accordingly, each of the cutouts 51C is provided with a hole 51D extending through the stacked part 52A. A region around the hole 51D is welded by the welded part 52C, for example, as illustrated in FIG. 9. Further, the hole 51D is welded by the welded part 52C, for example, as illustrated in FIG. 10.

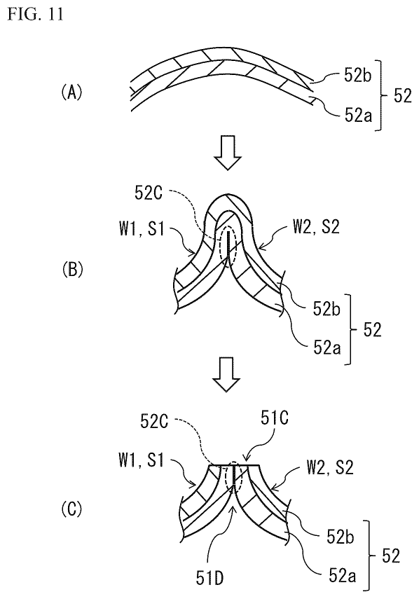

Next, a method of manufacturing the hole 51D will be described. Parts (A) to (C) of FIG. 11 illustrate an example of a manufacturing procedure of the hole 51D. First, the stacked body 52 shaped into a mountain shape is prepared (part (A) of FIG. 11). Thereafter, a ridge line of the mountain-shaped part of the stacked body 52 is sandwiched between two flat-plate-shaped mold pieces, and each of the mold pieces is heated to a predetermined temperature in that state. As a result, heat of each of the mold pieces propagates to the resin layer 52a in the stacked body 52, and a part of the resin layer 52a is welded to form the welded part 52C (part (B) of FIG. 11). Thereafter, the one or more cutouts 51C are formed at a location, of the stacked body 52, where the welded part 52C has been formed. Thus, the hole 51D is formed at the cutout 51C (part (C) of FIG. 11). The hole 51D is manufactured in this manner.

Next, effects of the battery pack 1 will be described.

Electronic equipment have been widely used, which has promoted development of a battery as a power source to be applied to the electronic equipment. In this case, in order to handle multiple batteries easily and safely, a battery pack including the multiple batteries has been proposed.

A technique related to a configuration of the battery pack has been considered in various ways. Specifically, a heat-absorbing member is in contact with a side surface of a battery unit, and the heat-absorbing member includes an outer film containing a gel fluid as a heat-absorbing agent inside (for example, see PTL 1).

Regarding a battery pack, there is a concern that it can be difficult to sufficiently cool a battery that has generated abnormal heat by a heat-absorbing member, depending on an arrangement or a structure of the heat-absorbing member.

In contrast, in the present embodiment, the container 51 housing the heat-absorbing agent 54 includes the stacked body 52 including the resin layer 52a and the metal layer 52b, and the region around the hole 51D extending through the stacked body 52 is welded by the welded part 52C. As a result, the welded part of the resin layer 52a is peeled off by heat of the battery 30 that has generated abnormal heat, and the heat-absorbing agent 54 released from the hole 51D comes into contact with and cools the battery 30 that has generated abnormal heat. Providing the welded part 52C of the resin layer 52a at a desired location of the container 51 thus makes it possible to effectively cool the battery 30 that has generated abnormal heat. Accordingly, it is possible to sufficiently cool the battery 30 that has generated abnormal heat by the heat-absorbing member 50.

In the present embodiment, the end wall W3 constituting a part of an end part of the container 51 is provided at the position adjacent to both of the arc walls W1 and W2, and the hole 51D is provided at the position spaced from the end wall W3. For example, each of the holes 51D is provided in the middle region in the longitudinal direction of the container 51. Thus, when forming the hole 51D in the manufacturing procedure of the heat-absorbing member 50, it is possible to make it unlikely that wrinkles will be formed at the end part of the container 51 to ruin a shape of the container 51.

In the present embodiment, the shape bent at an acute angle, i.e., the bent part, is provided, in the stacked body 52, at the boundary between the arc wall W1 and the arc wall W2, and the hole 51D is provided in the bent part. Further, the hole 51D is disposed, for example, close to the peripheral surfaces of both the first battery 30 described above and the second battery 30 described above. As a result, the welded part of the resin layer 52a is peeled off by heat of the battery 30 that has generated abnormal heat, and the heat-absorbing agent 54 released from the hole 51D comes into contact with and cools the battery 30 that has generated abnormal heat. Providing the welded part 52C of the resin layer 52a at a desired location of the container 51 thus makes it possible to effectively cool the battery 30 that has generated abnormal heat. Accordingly, it is possible to sufficiently cool the battery 30 that has generated abnormal heat by the heat-absorbing member 50.

In the present embodiment, each of the batteries 30 includes a cylindrical battery, and multiple heat-absorbing members 50 are each disposed at a position surrounded by four batteries 30 adjacent to each other. Thus, for example, when one battery 30 in the battery pack 1 generates abnormal heat, heat generated from the battery 30 that has generated abnormal heat is absorbed by the heat-absorbing member 50, which makes it possible to greatly reduce a rate of heat propagation to the battery 30 adjacent to the battery 30 that has generated abnormal heat.

In the present embodiment, the heat-absorbing member 50 has four arc walls W1. This makes it possible to increase a contact area between the heat-absorbing member 50 and the four batteries 30 disposed around the heat-absorbing member 50. As a result, it is possible for the heat-absorbing member 50 to efficiently absorb heat generated from the battery 30 that has generated abnormal heat.

Next, a description will be given of modification examples of the battery pack 1 according to an embodiment.

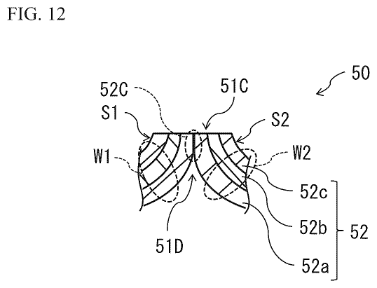

In the embodiment described above, the stacked body 52 may have a configuration in which the metal layer 52b is sandwiched between the resin layer 52a and a resin layer 52c, for example, as illustrated in FIG. 12. The resin layer 52c includes, for example, a resin material such as polyethylene, polystyrene, polypropylene, or polycarbonate. In this case, the hole 51D extends through the resin layer 52c. In this manner, the metal layer 52b is covered with the resin layer 52c, which makes it possible to prevent the metal layer 52b from being short-circuited to an electric conductor in the battery module 20.

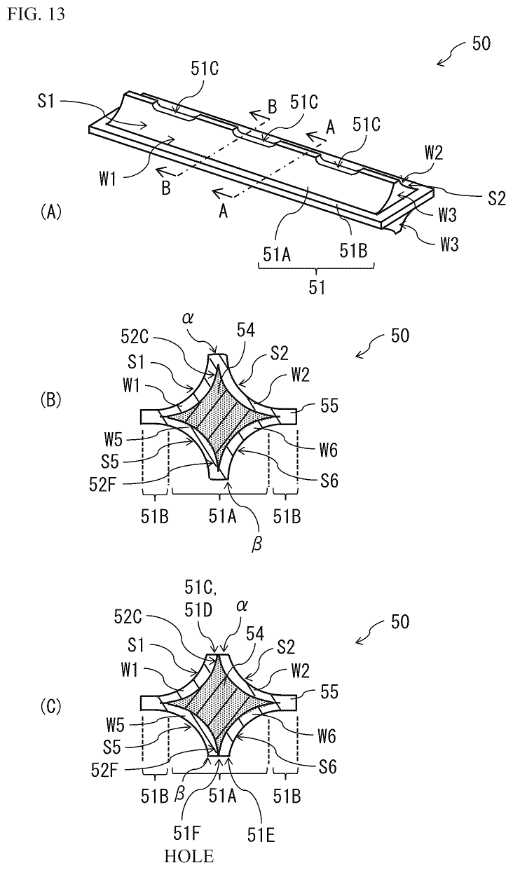

Part (A) of FIG. 13 illustrates a perspective configuration example of the heat-absorbing member 50 according to the present modification example. Part (B) of FIG. 13 illustrates a sectional configuration example of the heat-absorbing member 50 of part (A) of FIG. 13 taken along line A-A. Part (C) of FIG. 13 illustrates a sectional configuration example of the heat-absorbing member 50 of part (A) of FIG. 13 taken along line B-B.

In the above-described embodiment and modification examples thereof, the heat-absorbing member 50 may include a tubular stacked body 55, for example, as illustrated in part (B) of FIG. 13 and part (C) of FIG. 13. The stacked body 55 has, for example, the arc walls W1 and W2, the arc surfaces S1 and S2, arc walls W5 and W6, and arc surfaces S5 and S6. The two arc walls W5 and W6 and the two arc surfaces S5 and S6 each have a concave shape conforming to the outer peripheral surface of the battery 30. The arc wall W6 is disposed at a position adjacent to the arc wall W5. The arc surface S6 is disposed at a position adjacent to the arc surface S5.

The stacked body 55 corresponds to a specific example of the “first stacked part” and the “second stacked part” of the present technology. The arc wall W5 corresponds to a specific example of a “fourth stacked part” of the present technology. The arc wall W6 corresponds to a specific example of a “fifth stacked part” of the present technology. The heat-absorbing member 50 further has the end wall W3 disposed at a position adjacent to both of the arc walls W1 and W2, and the end wall W3 disposed at a position adjacent to both of the arc walls W5 and W6.

The container 51 is formed by, for example, heating and shaping the heat-absorbing agent 54 and the stacked body 55 in a state where the heat-absorbing agent 54 is covered with the cylindrical stacked body 55. The container 51 includes the housing part 51A housing the heat-absorbing agent 54 and the flange part 51B provided around the housing part 51A, for example, as illustrated in part (A) of FIG. 13, part (B) of FIG. 13, and part (C) of FIG. 13. The housing part 51A corresponds to a substantially rhombic-prism-shaped part, of the container 51, constituted by the arc walls W1 and W2, four end walls W3, and the arc walls W5 and W6. The flange part 51B corresponds to a plate-shaped part, of the container 51, provided to surround the housing part 51A, as viewed from a direction allowing a full view of the arc walls W1 and W2. The container 51 (the stacked body 55) includes, for example, the resin layer 52a and the metal layer 52b in this order from the side closer to the heat-absorbing agent 54.

The stacked body 55 has a shape that is bent at an acute angle at the boundary α between the arc wall W1 and the arc wall W2, for example, as illustrated in part (B) of FIG. 13. At the boundary α between the arc wall W1 and the arc wall W2, i.e., the bent part, a part of the resin layer 52a of the arc wall W1 and a part of the resin layer 52a of the arc wall W2 are welded to each other, for example, as illustrated in part (B) of FIG. 13. The boundary α between the arc wall W1 and the arc wall W2, i.e., the bent part, is sealed by, for example, adhesion between the part of the resin layer 52a of the arc wall W1 and the part of the resin layer 52a of the arc wall W2. A part where the part of the resin layer 52a of the arc wall W1 and the part of the resin layer 52a of the arc wall W2 are welded to each other for sealing is the welded part 52C in part (B) of FIG. 13.

The stacked body 55 has a shape that is bent at an acute angle at a boundary p between the arc wall W5 and the arc wall W6, for example, as illustrated in part (B) of FIG. 13. At the boundary p between the arc wall W5 and the arc wall W6, i.e., the bent part, a part of the resin layer 52a of the arc wall W5 and a part of the resin layer 52a of the arc wall W6 are welded to each other, for example, as illustrated in part (B) of FIG. 13. A part where the part of the resin layer 52a of the arc wall W5 and the part of the resin layer 52a of the arc wall W6 are welded to each other is a welded part 52F in part (B) of FIG. 13.

The stacked body 55 has the one or more cutouts 51C at the boundary α between the arc wall W1 and the arc wall W2, i.e., the bent part, for example, as illustrated in part (A) of FIG. 13 and part (C) of FIG. 13. The one or more cutouts 51C are disposed close to the peripheral surfaces of both the first battery 30 and the second battery 30 described above. The one or more cutouts 51C are provided at one or more positions spaced from the end wall W3. Each of the cutouts 51C is provided in the middle region in the longitudinal direction of the container 51. Here, the term “middle region” refers to, for example, the region that is away from each of the end walls W3 by the length equal to the height of the end wall W3, at the boundary α, i.e., the bent part, extending between the two end walls W3. The welded part 52C is exposed on the surface of each of the cutouts 51C, for example, as illustrated in part (C) of FIG. 13. In other words, each of the cutouts 51C extends through the stacked body 55. Therefore, at each of the cutouts 51C, when the welded part 52C is melted by, for example, heat of the battery 30 that has generated abnormal heat, the heat-absorbing agent 54 leaks to the outside (e.g., the peripheral surface of the battery 30 that has generated abnormal heat) via each of the cutouts 51C. Accordingly, each of the cutouts 51C is provided with the hole 51D extending through the stacked body 55.

The stacked body 55 further has one or more cutouts 51E at the boundary p between the arc wall W5 and the arc wall W6, i.e., the bent part, for example, as illustrated in part (C) of FIG. 13. The one or more cutouts 51E are disposed close to the peripheral surfaces of both the first battery 30 and the second battery 30 described above. The one or more cutouts 51E are provided at one or more positions spaced from the end wall W3. Each of the cutouts 51E is provided in the middle region in the longitudinal direction of the container 51. Here, the term “middle region” refers to, for example, the region that is away from each of the end walls W3 by the length equal to the height of the end wall W3, at the boundary p, i.e., the bent part, extending between the two end walls W3. The welded part 52F is exposed on the surface of each of the cutouts 51E, for example, as illustrated in part (C) of FIG. 13. In other words, each of the cutouts 51E extends through the stacked body 55. Therefore, at each of the cutouts 51E, when the welded part 52F is melted by, for example, heat of the battery 30 that has generated abnormal heat, the heat-absorbing agent 54 leaks to the outside (e.g., the peripheral surface of the battery 30 that has generated abnormal heat) via each of the cutouts 51E. Accordingly, each of the cutouts 51E is provided with a hole 51F extending through the stacked body 55.

Next, a method of manufacturing the holes 51D and 51F will be described. First, the stacked body 55 shaped into a mountain shape is prepared. Thereafter, a ridge line of the mountain-shaped part of the stacked body 55 is sandwiched between two flat-plate-shaped mold pieces, and each of the mold pieces is heated to a predetermined temperature in that state. As a result, heat of each of the mold pieces propagates to the resin layer 52a in the stacked body 55, and a part of the resin layer 52a is welded to form the welded part 52C. Thereafter, the one or more cutouts 51C and the one or more cutouts 51E are formed at a location, of the stacked body 55, where the welded part 52C has been formed. Thus, the hole 51D is formed at the cutout 51C, and the hole 51F is formed at the cutout 51E. The holes 51D and 51F are manufactured in this manner.

In the present modification example, the container 51 housing the heat-absorbing agent 54 includes the stacked body 52 including the resin layer 52a and the metal layer 52b, and the regions around the holes 51D and 51F extending through the stacked body 52 are welded by the welded parts 52C and 52F. As a result, the welded parts of the resin layer 52a are peeled off by heat of the battery 30 that has generated abnormal heat, and the heat-absorbing agent 54 released from the holes 51D and 51F comes into contact with and cools the battery 30 that has generated abnormal heat. Providing the welded parts 52C and 52F of the resin layer 52a at desired locations of the container 51 thus makes it possible to effectively cool the battery 30 that has generated abnormal heat. Accordingly, it is possible to sufficiently cool the battery 30 that has generated abnormal heat by the heat-absorbing member 50.

In the present modification example, the shape bent at an acute angle, i.e., the bent part, is provided, in the stacked body 55, at the boundary α between the arc wall W1 and the arc wall W2, and the hole 51D is provided in the bent part. Further, the hole 51D is disposed, for example, close to the peripheral surfaces of both the first battery 30 described above and the second battery 30 described above. As a result, the welded part of the resin layer 52a is peeled off by heat of the battery 30 that has generated abnormal heat, and the heat-absorbing agent 54 released from the hole 51D comes into contact with and cools the battery 30 that has generated abnormal heat. Accordingly, providing the welded part 52C of the resin layer 52a at a desired location of the container 51 makes it possible to effectively cool the battery 30 that has generated abnormal heat.

In the present modification example, further, the shape bent at an acute angle, i.e., the bent part, is provided, in the stacked body 55, at the boundary p between the arc wall W5 and the arc wall W6, and the hole 51F is provided in the bent part. Further, the hole 51F is disposed, for example, close to the peripheral surfaces of both the first battery 30 described above and the second battery 30 described above. As a result, the welded part of the resin layer 52a is peeled off by heat of the battery 30 that has generated abnormal heat, and the heat-absorbing agent 54 released from the hole 51F comes into contact with and cools the battery 30 that has generated abnormal heat. Accordingly, providing the welded part 52F of the resin layer 52a at a desired location of the container 51 makes it possible to effectively cool the battery 30 that has generated abnormal heat.

In the present modification example, the end wall W3 constituting a part of the end part of the container 51 is provided at the position adjacent to both of the arc walls W1 and W2, and the hole 51D is provided at the position spaced from the end wall W3. For example, each of the holes 51D is provided in the middle region in the longitudinal direction of the container 51. In the present modification example, further, the end wall W3 constituting a part of the end part of the container 51 is provided at the position adjacent to both of the arc walls W5 and W6, and the hole 51F is provided at the position spaced from the end wall W3. For example, each of the holes 51F is provided in the middle region in the longitudinal direction of the container 51. Thus, when forming the holes 51D and 51F in the manufacturing procedure of the heat-absorbing member 50, it is possible to make it unlikely that wrinkles will be formed at the end part of the container 51 to ruin the shape of the container 51.

In the present modification example, the stacked body 55 may have a configuration in which the metal layer 52b is sandwiched between the resin layers 52a and 52c. In this case, the holes 51D and 51F extend through the resin layer 52c. In this manner, the metal layer 52b is covered with the resin layer 52c, which makes it possible to more reliably prevent the metal layer 52b from being short-circuited to an electric conductor in the battery module 20.

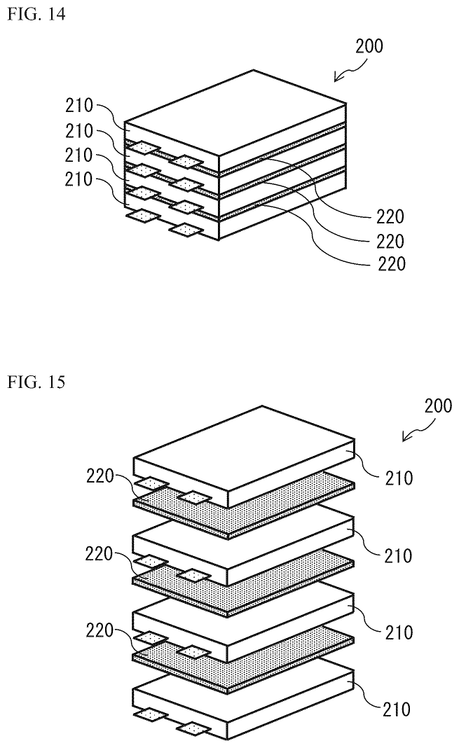

In the above-described embodiment and modification examples thereof, a battery module 200 illustrated in FIGS. 14 and 15, for example, may be provided in place of the battery module 20. FIG. 14 illustrates a perspective configuration example of the battery module 200. FIG. 15 illustrates an exploded perspective configuration example of the battery module 200. The battery module 200 includes multiple batteries 210 and multiple heat-absorbing members 220, for example, as illustrated in FIGS. 14 and 15.

The multiple batteries 210 are stacked in a thickness direction of the battery 210. The thickness direction of the battery 210 refers to a direction in which a top surface of the battery 210 and a bottom surface of the battery 210 face each other. The top surface of the battery 210 refers to the top surface of the battery 210 in a state where the battery module 200 is housed in the outer casing 10. The bottom surface of the battery 210 refers to the bottom surface of the battery 210 in the state where the battery module 200 is housed in the outer casing 10. The multiple heat-absorbing members 220 are stacked in the same direction as the stacking direction of the multiple batteries 210. The multiple batteries 210 and the multiple heat-absorbing members 220 are alternately arranged in the stacking direction of the multiple batteries 210. One heat-absorbing member 220 is provided between two batteries 210 adjacent to each other. The heat-absorbing member 220 is in contact with each of the two batteries 210 disposed above and below the heat-absorbing member 220.

The multiple batteries 210 are electrically coupled to each other via multiple metal tabs. The battery 210 is a flat-plate-shaped battery of a laminated film type. The battery 210 includes, for example, a positive electrode and a negative electrode on a side surface thereof. In the battery module 200, for example, some of the multiple batteries 210 are coupled in series with each other by the metal tabs. Further, when the batteries 210 coupled in series with each other are referred to as a series unit, multiple series units are coupled in parallel with each other by the metal tabs. Note that how the multiple batteries 210 are coupled to each other is not limited to the above.

Each of the batteries 210 is a primary battery or a secondary battery. When each of the batteries 210 is a secondary battery, the secondary battery is not particularly limited in kind, but is specifically, for example, a lithium-ion secondary battery in which a battery capacity is obtainable through insertion and extraction of lithium ions. Hereinafter, a case in which each of the batteries 210 is a secondary battery (a lithium-ion secondary battery) will be described. In other words, the battery pack 1 described below is a power source including multiple secondary batteries.

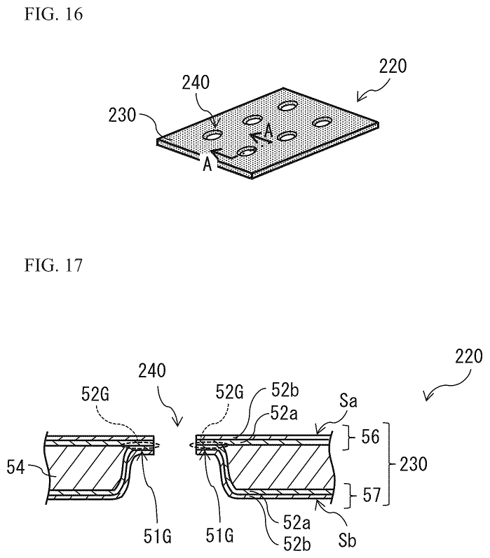

FIG. 16 illustrates a perspective configuration example of the heat-absorbing member 220. FIG. 17 illustrates a sectional configuration example of the heat-absorbing member 220 taken along line A-A. The heat-absorbing member 220 has a flat plate shape, for example, as illustrated in FIG. 16. The heat-absorbing member 220 includes the heat-absorbing agent 54 and a container 230 covering the heat-absorbing agent 54, for example, as illustrated in FIG. 17.

The container 230 has a first surface Sa disposed at a position adjacent to a first battery 210, and a second surface Sb opposed to the first surface Sa with the heat-absorbing agent 54 interposed therebetween, for example, as illustrated in FIG. 17. The second surface Sb is disposed at a position adjacent to a second battery 210 that is adjacent to the first battery 210. The container 230 has one or more through holes 240 extending through the first surface Sa and the second surface Sb, for example, as illustrated in FIG. 17. A region around each of the through holes 240 is sealed by a part, of the first surface Sa, around the through hole 240 and a part, of the second surface Sb, around the through hole 240.

The container 230 includes a stacked body 56 having the first surface Sa and a stacked body 57 having the second surface Sb, for example, as illustrated in FIG. 17. The stacked bodies 56 and 57 each include the resin layer 52a and the metal layer 52b in this order from the side closer to the heat-absorbing agent 54. Each of the through holes 240 extends through the first surface Sa and the second surface Sb, and extends through both the stacked body 56 and the stacked body 57.

The region around the through hole 240 is sealed by the part, of the first surface Sa, around the through hole 240 and the part, of the second surface Sb, around the through hole 240. The region around the through hole 240 is sealed by a part, of the resin layer 52a of the stacked body 56, around the through hole 240 and a part, of the resin layer 52a of the stacked body 57, around the through hole 240. Apart where the part, of the resin layer 52a of the stacked body 56, around the through hole 240 and the part, of the resin layer 52a of the stacked body 57, around the through hole 240 are welded to each other for sealing is a welded part 52G in FIG. 17.

The welded part 52G is exposed on an end surface (an inner surface) of each of the through holes 240. Therefore, at each of the through holes 240, when the welded part 52G is melted by, for example, heat of the battery 30 that has generated abnormal heat, the heat-absorbing agent 54 is released to the outside (e.g., the peripheral surface of the battery 30 that has generated abnormal heat) via each of the through holes 240. Accordingly, the end surface (the inner surface) of each of the through holes 240 is provided with a release part 51G extending through the end surface (the inner surface) of each of the through holes 240. A region around the release part 51G is welded by the welded part 52G, for example, as illustrated in FIG. 17. Further, the release part 51G is welded by the welded part 52G, for example, as illustrated in FIG. 17.

The welded part 52G and the release part 51G are provided at a location closer to the first surface Sa than to the second surface Sb, for example, as illustrated in FIG. 17. In other words, the welded part 52G and the release part 51G are provided at a location closer to the battery 2220 provided on the side of the first surface Sa than to the battery 220 provided on the side of the second surface Sb.

In the present modification example, the container 230 is provided with the first surface Sa, the second surface Sb, and the one or more through holes 240, and the region around each of the through holes 240 is sealed (welded) by the part, of the first surface Sa, around the through hole 230 and the part, of the second surface Sb, around the through hole 240. As a result, the welded part 52G is peeled off by heat of the battery 30 that has generated abnormal heat, and the heat-absorbing agent 54 released from the welded part 52G comes into contact with and cools the battery 30 that has generated abnormal heat. Providing the through hole 240 and the welded part 52G at a desired location of the container 230 thus makes it possible to effectively cool the battery 30 that has generated abnormal heat. Accordingly, it is possible to sufficiently cool the battery 30 that has generated abnormal heat by the heat-absorbing member 50.

In the present modification example, the region around each of the through holes 240 is sealed (welded) by the part, of the resin layer 52a of the stacked body 56, around the through hole 240 and the part, of the resin layer 52a of the stacked body 57, around the through hole 240. As a result, the welded part 52G is peeled off by heat of the battery 30 that has generated abnormal heat, and the heat-absorbing agent 54 released from the welded part 52G comes into contact with and cools the battery 30 that has generated abnormal heat. Providing the through hole 240 and the welded part 52G at a desired location of the container 230 thus makes it possible to effectively cool the battery 30 that has generated abnormal heat. Accordingly, it is possible to sufficiently cool the battery 30 that has generated abnormal heat by the heat-absorbing member 50.

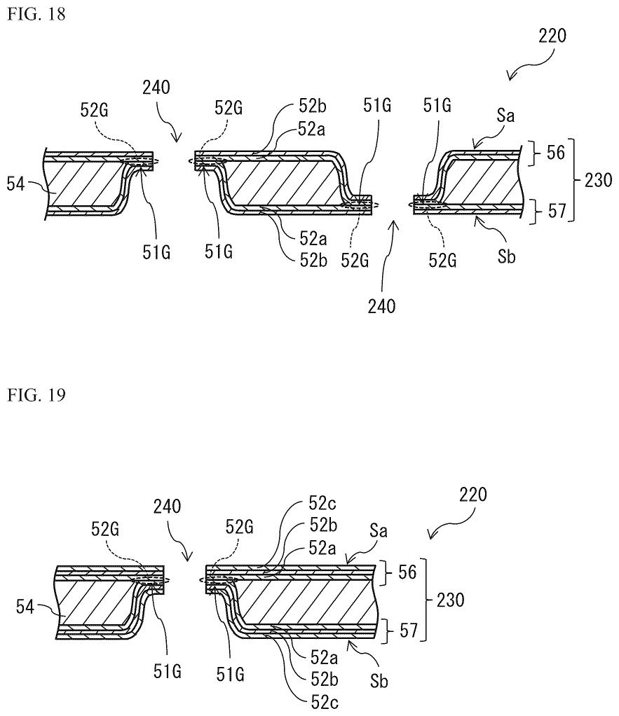

In the present modification example, the container 230 may be provided with: the through hole 240 where the welded part 52G and the release part 51G are provided at a location closer to the first surface Sa than to the second surface Sb; and the through hole 240 where the welded part 52G and the release part 51G are provided at a location closer to the second surface Sb than to the first surface Sa, for example, as illustrated in FIG. 18. In other words, in the present modification example, the container 230 may be provided with: the through hole 240 where the welded part 52G and the release part 51G are provided at a location closer to the battery 220 provided on the side of the first surface Sa than to the battery 220 provided on the side of the second surface Sb; and the through hole 240 where the welded part 52G and the release part 51G are provided at a location closer to the battery 220 provided on the side of the second surface Sb than to the battery 220 provided on the side of the first surface Sa. In this case, when one of the battery 220 provided on the side of the first surface Sa or the battery 220 provided on the side of the second surface Sb generates abnormal heat, the welded part 52G provided at a location close to the battery 220 that has generated abnormal heat is peeled off by heat of the battery 30 that has generated abnormal heat, and the heat-absorbing agent 54 released from the welded part 52G comes into contact with and cools the battery 30 that has generated abnormal heat. Providing the through hole 240 and the welded part 52G at a desired location of the container 230 thus makes it possible to effectively cool the battery 30 that has generated abnormal heat. Accordingly, it is possible to sufficiently cool the battery 30 that has generated abnormal heat by the heat-absorbing member 50.

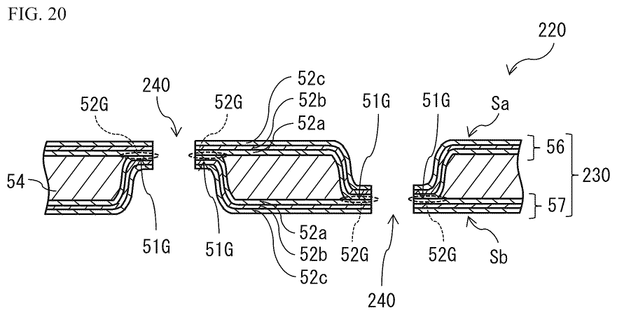

In the present modification example, the stacked body 55 may have a configuration in which the metal layer 52b is sandwiched between the resin layers 52a and 52c, for example, as illustrated in FIGS. 19 and 20. In this case, the holes 51D and 51F extend through the resin layer 52c. In this manner, the metal layer 52b is covered with the resin layer 52c, which makes it possible to prevent the metal layer 52b from being short-circuited with an electric conductor in the battery module 20.

Although the present technology has been described above with reference to various embodiments including modification examples, the present technology is not limited thereto, and is modifiable in a variety of ways.

For example, although lithium is used as the electrode reactant of the secondary battery in the above-described embodiment and modification examples thereof, the electrode reactant is not particularly limited in kind. Specifically, the electrode reactant may be another element belonging to group 1 in the long period periodic table, such as sodium or potassium. The electrode reactant may be an element belonging to group 2 in the long period periodic table, such as magnesium or calcium. The electrode reactant may be another light metal such as aluminum.

The effects described herein are mere examples and are not limited thereto, and other effects may be obtained.

Note that the present technology may have any of the following configurations according to an embodiment.

<1>

A battery pack including:
a battery; and
a heat-absorbing member including a heat-absorbing agent and a container housing the heat-absorbing agent, in which
the heat-absorbing member is disposed at a position adjacent to the battery,
the container includes a first stacked body including a first resin layer and a first metal layer in this order from a side closer to the heat-absorbing agent,
the first stacked body has a first hole extending through the first resin layer and the first metal layer, and a region around the first hole is sealed by the first resin layer around the first hole.
   <2>

The battery pack according to <1>, in which
the battery includes a cylindrical battery,
a plurality of the batteries is arranged side by side,
the container has a columnar shape extending in a longitudinal direction of each of the batteries,
the first stacked body includes
   a first stacked part extending along a peripheral surface of a first battery, and
   a second stacked part disposed at a position adjacent to the first stacked part, and extending along a peripheral surface of a second battery that is adjacent to the first battery,
the first stacked body has the first hole at a boundary between the first stacked part and the second stacked part, and
the region around the first hole is sealed by adhesion between the first resin layer of the first stacked part and the first resin layer of the second stacked part.
   <3>

The battery pack according to <2>, in which
the first stacked body further includes a third stacked part that is disposed at a position adjacent to both the first stacked part and the second stacked part and constitutes a part of an end part of the container, and
the first hole is provided, at the boundary, at a position spaced from the third stacked part.
   <4>

The battery pack according to <3>, in which
the first hole is provided in a middle region in a longitudinal direction of the container.
   <5>

The battery pack according to any one of <2> to <4>, in which
the first stacked body has a shape that is bent at an acute angle at the boundary, and
the first hole is disposed close to the peripheral surfaces of both the first battery and the second battery.
   <6>

The battery pack according to <2>, in which
the container includes a second stacked body including a second resin layer and a second metal layer in this order from the side closer to the heat-absorbing agent,
the second stacked body has a second hole extending through the second resin layer and the second metal layer, and
a region around the second hole is sealed by the second resin layer around the second hole.
   <7>

The battery pack according to <6>, in which
the second stacked body includes
   a fourth stacked part extending along a peripheral surface of a third battery, and
   a fifth stacked part disposed at a position adjacent to the fourth stacked part, and extending along a peripheral surface of a fourth battery that is adjacent to the third battery,
the second stacked body has the second hole at a boundary between the fourth stacked part and the fifth stacked part, and
the region around the second hole is sealed by adhesion between the second resin layer of the fourth stacked part and the second resin layer of the fifth stacked part.
   <8>

The battery pack according to <7>, in which
the second stacked body has a shape that is bent at an acute angle at the boundary between the fourth stacked part and the fifth stacked part, and
the second hole is disposed adjacent to the peripheral surfaces of both the third battery and the fourth battery.
   <9>

The battery pack according to any one of <2> to <8>, in which
the first stacked body includes a third resin layer covering the first metal layer on an outside of the first metal layer, and
the first hole extends also through the third resin layer.
   <10>

The battery pack according to any one of <6> to <9>, in which
the second stacked body includes a fourth resin layer covering the second metal layer on an outside of the second metal layer, and
the second hole extends also through the fourth resin layer.
   <11>

A battery pack including:
a first battery; and
a heat-absorbing member including a heat-absorbing agent and a container housing the heat-absorbing agent, in which
the first battery and the container each have a flat plate shape,
the container has
   a first surface disposed at a position adjacent to the first battery,
   a second surface opposed to the first surface with the heat-absorbing agent interposed therebetween, and
   a first through hole extending through the first surface and the second surface, and
a region around the first through hole is sealed by a part, of the first surface, around the first through hole and a part, of the second surface, around the first through hole.
   <12>

The battery pack according to <11>, in which
the container includes
   a first stacked body having the first surface, and
   a second stacked body having the second surface,
the first stacked body includes a first resin layer and a first metal layer in this order from a side closer to the heat-absorbing agent,
the second stacked body includes a second resin layer and a second metal layer in this order from the side closer to the heat-absorbing agent,
the first through hole extends through both the first stacked body and the second stacked body, and
the region around the first through hole is sealed by a part, of the first resin layer, around the first through hole and a part, of the second resin layer, around the first through hole.
   <13>

The battery pack according to <11>, further including
a second battery having a flat plate shape, in which
the second surface is disposed at a position adjacent to the second battery,
the container further has a second through hole extending through the first surface and the second surface,
a region around the second through hole is sealed by a part, of the first surface, around the second through hole and a part, of the second surface, around the second through hole,
a part where the region around the first through hole is sealed by the part, of the first surface, around the first through hole and the part, of the second resin layer, around the first through hole is provided at a location closer to the first battery than to the second battery, and
a part where the region around the second through hole is sealed by the part, of the first resin layer, around the second through hole and the part, of the second resin layer, around the second through hole is provided at a location closer to the second battery than to the first battery.
   <14>

The battery pack according to <13>, in which
the container includes
   a first stacked body having the first surface, and
   a second stacked body having the second surface,
the first stacked body includes a first resin layer and a first metal layer in this order from a side closer to the heat-absorbing agent,
the second stacked body includes a second resin layer and a second metal layer in this order from the side closer to the heat-absorbing agent,
the first through hole extends through both the first stacked body and the second stacked body,
the second through hole extends through both the first stacked body and the second stacked body,
a part where the region around the first through hole is sealed by a part, of the first resin layer, around the first through hole and a part, of the second resin layer, around the first through hole is provided at a location closer to the first battery than to the second battery, and a part where the region around the second through hole is sealed by a part, of the first resin layer, around the second through hole and a part, of the second resin layer, around the second through hole is provided at a location closer to the second battery than to the first battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery; and
a heat-absorbing member including a heat-absorbing agent and a container housing the heat-absorbing agent, wherein
the heat-absorbing member is disposed at a position adjacent to the battery,
the container includes a first stacked body including a first resin layer and a first metal layer in this order from a side closer to the heat-absorbing agent,
the first stacked body has a first hole extending through the first resin layer and the first metal layer, and
a region around the first hole is sealed by the first resin layer around the first hole.

2. The battery pack according to claim 1, wherein
the battery comprises a cylindrical battery,
a plurality of the batteries is arranged side by side,
the container has a columnar shape extending in a longitudinal direction of each of the batteries,
the first stacked body includes
a first stacked part extending along a peripheral surface of a first battery, and
a second stacked part disposed at a position adjacent to the first stacked part, and extending along a peripheral surface of a second battery that is adjacent to the first battery,
the first stacked body has the first hole at a boundary between the first stacked part and the second stacked part, and
the region around the first hole is sealed by adhesion between the first resin layer of the first stacked part and the first resin layer of the second stacked part.

3. The battery pack according to claim 2, wherein
the first stacked body further includes a third stacked part that is disposed at a position adjacent to both the first stacked part and the second stacked part and constitutes a part of an end part of the container, and
the first hole is provided, at the boundary, at a position spaced from the third stacked part.

4. The battery pack according to claim 3, wherein
the first hole is provided in a middle region in a longitudinal direction of the container.

5. The battery pack according to claim 2, wherein
the first stacked body has a shape that is bent at an acute angle at the boundary, and
the first hole is disposed close to the peripheral surfaces of both the first battery and the second battery.

6. The battery pack according to claim 2, wherein
the container includes a second stacked body including a second resin layer and a second metal layer in this order from the side closer to the heat-absorbing agent,
the second stacked body has a second hole extending through the second resin layer and the second metal layer, and
a region around the second hole is sealed by the second resin layer around the second hole.

7. The battery pack according to claim 6, wherein
the second stacked body includes
a fourth stacked part extending along a peripheral surface of a third battery, and
a fifth stacked part disposed at a position adjacent to the fourth stacked part, and extending along a peripheral surface of a fourth battery that is adjacent to the third battery,
the second stacked body has the second hole at a boundary between the fourth stacked part and the fifth stacked part, and
the region around the second hole is sealed by adhesion between the second resin layer of the fourth stacked part and the second resin layer of the fifth stacked part.

8. The battery pack according to claim 7, wherein
the second stacked body has a shape that is bent at an acute angle at the boundary between the fourth stacked part and the fifth stacked part, and
the second hole is disposed adjacent to the peripheral surfaces of both the third battery and the fourth battery.

9. The battery pack according to claim 2, wherein
the first stacked body includes a third resin layer covering the first metal layer on an outside of the first metal layer, and
the first hole extends also through the third resin layer.

10. The battery pack according to claim 6, wherein
the second stacked body includes a fourth resin layer covering the second metal layer on an outside of the second metal layer, and
the second hole extends also through the fourth resin layer.

11. A battery pack comprising:
a first battery; and
a heat-absorbing member including a heat-absorbing agent and a container housing the heat-absorbing agent, wherein
the first battery and the container each have a flat plate shape,
the container has
a first surface disposed at a position adjacent to the first battery,
a second surface opposed to the first surface with the heat-absorbing agent interposed therebetween, and
a first through hole extending through the first surface and the second surface, and
a region around the first through hole is sealed by a part, of the first surface, around the first through hole and a part, of the second surface, around the first through hole.

12. The battery pack according to claim 11, wherein
the container includes
a first stacked body having the first surface, and
a second stacked body having the second surface,
the first stacked body includes a first resin layer and a first metal layer in this order from a side closer to the heat-absorbing agent,
the second stacked body includes a second resin layer and a second metal layer in this order from the side closer to the heat-absorbing agent,
the first through hole extends through both the first stacked body and the second stacked body, and
the region around the first through hole is sealed by a part, of the first resin layer, around the first through hole and a part, of the second resin layer, around the first through hole.

13. The battery pack according to claim 11, further comprising
a second battery having a flat plate shape, wherein
the second surface is disposed at a position adjacent to the second battery,
the container further has a second through hole extending through the first surface and the second surface,
a region around the second through hole is sealed by a part, of the first surface, around the second through hole and a part, of the second surface, around the second through hole,
a part where the region around the first through hole is sealed by the part, of the first surface, around the first through hole and the part, of the second resin layer, around the first through hole is provided at a location closer to the first battery than to the second battery, and
a part where the region around the second through hole is sealed by the part, of the first resin layer, around the second through hole and the part, of the second resin layer, around the second through hole is provided at a location closer to the second battery than to the first battery.

14. The battery pack according to claim 13, wherein
the container includes
a first stacked body having the first surface, and
a second stacked body having the second surface,
the first stacked body includes a first resin layer and a first metal layer in this order from a side closer to the heat-absorbing agent,
the second stacked body includes a second resin layer and a second metal layer in this order from the side closer to the heat-absorbing agent,
the first through hole extends through both the first stacked body and the second stacked body,
the second through hole extends through both the first stacked body and the second stacked body,
a part where the region around the first through hole is sealed by a part, of the first resin layer, around the first through hole and a part, of the second resin layer, around the first through hole is provided at a location closer to the first battery than to the second battery, and
a part where the region around the second through hole is sealed by a part, of the first resin layer, around the second through hole and a part, of the second resin layer, around the second through hole is provided at a location closer to the second battery than to the first battery.
